(19) United States
(12) Patent Application Publication
(10) Pub. No.: US 2004/0234162 A1
(43) Pub. Date: Nov. 25, 2004

(54) Digital image processing method in particular for satellite images

(76) Inventors: Andre Jalobeanu, Nice (FR); Laure Blanc-Feraud, Saint Laurent Du Var (FR); Josiane Zerubia, Cannes La Bocca (FR)

Correspondence Address: FOLEY AND LARDNER, SUITE 500, 3000 K STREET NW, WASHINGTON, DC, 20007, US

(21) Appl. No.: 10/485,090

(22) PCT Filed: Jul. 29, 2002
(86) PCT No.: PCT/FR02/02720

(30) Foreign Application Priority Data
Jul. 30, 2001 (FR) 01/10189

(51) Int. Cl. G06K 9/36

(52) U.S. Cl. 382/280

(57) ABSTRACT

The invention concerns processing of digital images, captured by detection of electromagnetic waves, such as satellite pictures. The inventive processing consists in applying a parameterable fractal modelling (M) to Fourier transforms of the pixels of the image and comparing (22) the thus modelled transforms (aᵢⱼ^{q, wo}) to the initial transforms (aᵢⱼ) to bring the parameters (q, w₀) closer to the fractal model, and if required, the parameters (α,μ,σ) of a transfer function of the instrument which has captured the image.

The invention relates to the processing of digital images acquired by the detection of electromagnetic waves, such as pictures taken by satellites or from the air.

Images of this kind are prone to becoming blurred or noisy as a result of the instrument which allows them to be obtained coming out of adjustment or being subject to degradation. It is in this way that, in a case where detection is optical, defocusing or aberrations, or again a relative movement of the instrument (panning), changes the transfer function of the instrument and adversely affects the sharpness of the image. In the case of opto-electronic detection (CCD sensors), noise in the sensors degrades the standard of image obtained even more. Although the transfer function of the instrument may be capable of being set to parameters, its parameters are thus prone to varying in an uncontrolled way.

One of the objects of the present invention is to provide, for each image or image type detected, an image model which is as exact as possible and to do so irrespective of any variation in the parameters of the transfer function of the instrument which detects the image.

Another object of the present invention is to provide this model in a form which can be set to parameters, together with the parameters of the model associated with an image or an image type.

Another object of the present invention is to provide a model of this kind which is able to be compatible with a model which can be set to parameters of the transfer function of the instrument, with a view to also obtaining the parameters of this transfer function and, from there, to reconstructing a sharp and noise-free image if required.

To this end, the invention firstly proposes a method of processing digital images which are acquired by the detection of electromagnetic waves.

In accordance with an important feature of the invention, the method comprises the following steps:

a) recovering the image data relating to constituent elements of an initial image,

b) applying at least one spectral transformation to at least some of the image elements,

c) in the case of at least some of these elements, applying overall statistical modelling, which can be set to parameters, to the transforms of the elements, and

d) comparing the modelled transforms to the initial transforms in order to obtain a close approximation of at least one parameter which comes into play in the statistical model applied.

In principle, the image elements keep the same characteristics as the image as a whole regardless of the scale (or size) of the image. What is meant by “overall modelling” is modelling which, when applied to each image element transform, amounts to applying modelling to a transform of the image as a whole while preserving its blurring or noise characteristics.

The transformation in step b) is preferably a Fourier transform, or again a discrete cosine transform, and the statistical model is preferably of the fractal type and comprises the assignment of at least one parameter, which parameter is suitable for defining, in the frequency domain, a statistical variation of the coefficients coming from the transform of each element.

In one embodiment, the method makes provision for quantitative determination of this parameter on the basis of the comparison in step d), to enable, if required, the quantitative value of a second parameter, which second parameter is also capable of playing a part in the model, to be derived therefrom at a later stage.

In another embodiment, the method makes provision for the assignment of a predetermined quantitative value to this parameter to enable the quantitative value of a second parameter, which second parameter also comes into play in the model, to be derived from the comparison in step d).

In yet another embodiment, the method makes provision for the assignment of approximated quantitative values to this parameter and to the second parameter, and for successive refinement, by the comparison in step d), of the quantitative value of at least the second parameter.

Step d) advantageously comprises searching for an extremum in a mathematical expression representative of the comparison performed, and preferably searching for a maximum probability.

In accordance with another advantageous feature of the invention, the statistical model also brings into play at least one instrument parameter which is subject to variations, and, in step c), a close approximation is advantageously obtained of this instrument parameter, which enables the initial image to be processed, if required, to improve its quality.

In the above embodiments, the second parameter mentioned may advantageously be said instrument parameter.

The method preferably comprises a step prior to step b) in which a modulation function of the instrument, which modulation function takes account of a loss of adjustment of the instrument, is modelled, said function bringing into play the afore-mentioned instrument parameter.

The present invention is also directed to an application of the above method to the processing of satellite or aerial images obtained by optical or infrared detection.

The present invention may also take the form of a device for putting the above method into practice, said device then comprising a module for statistical modelling which comprises an input for recovering spectral transforms of constituent elements of an initial image, and which is arranged:

to apply overall statistical modelling, which can be set to parameters, to at least some of the element transforms, and

to compare the modelled transforms with the initial transforms with a view to obtaining a close approximation of at least one parameter which comes into play in the statistical model applied.

Advantageously, the device may also operate both on the ground and on board an aerial vehicle of the satellite, aircraft or some other type.

In one embodiment, the device comprises memory means and calculating means to cause at least the modelling module to operate. The memory means contain program data relating to the modelling module and the calculating means are arranged to co-operate with the memory means to put the modelling module into practical operation.

As a variant, the modelling module comprises memory means and calculating means which are combined in one and the same component of the FPGA or VLSI type.

The above-mentioned program data relating to the modelling module forms an important means for putting the invention into practice. This being the case, the present invention is also directed to a computer software product intended to be stored in a device of the above type to enable at least the modelling module to be put into practical operation. This software product may also be stored in a withdrawable memory (a removable medium of the CD-ROM, floppy disk or some other type), may be loaded into a working memory or into a non-volatile memory of the device (by a connection to a remote network), or again may be stored in the non-volatile memory of the device.

Other features and advantages of the invention will become apparent from perusal of the detailed description below and from the accompanying drawings, in which:

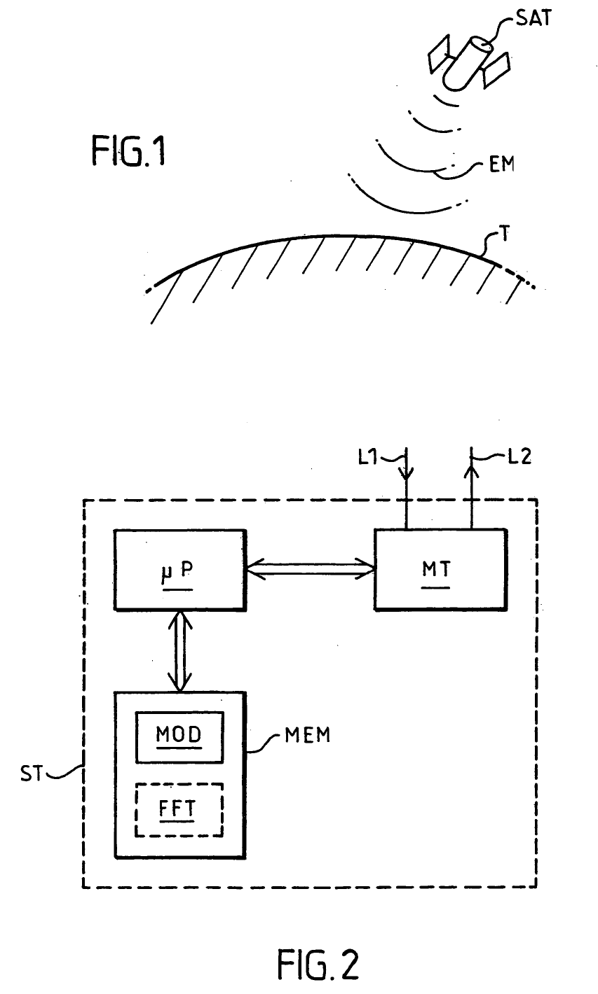

FIG. 1 is a diagrammatic view of an instrument for taking pictures, in operation.

FIG. 2 is a diagrammatic view of a simplified structure of the device according to the invention, in a first embodiment.

FIG. 3 is a diagrammatic view of a simplified structure of the device, in a second embodiment.

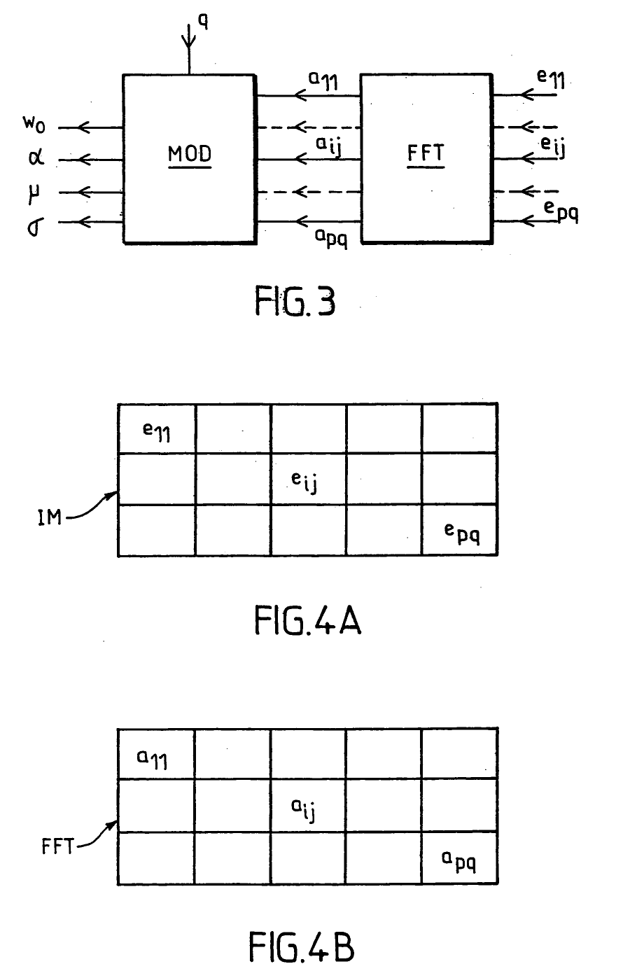

FIG. 4A is a diagrammatic view of a digitised image and shows the image elements (pixels).

FIG. 4B is a diagrammatic view of a Fourier transform FFT of the image, in the example described, in the frequency domain and when applied to blocks of image elements.

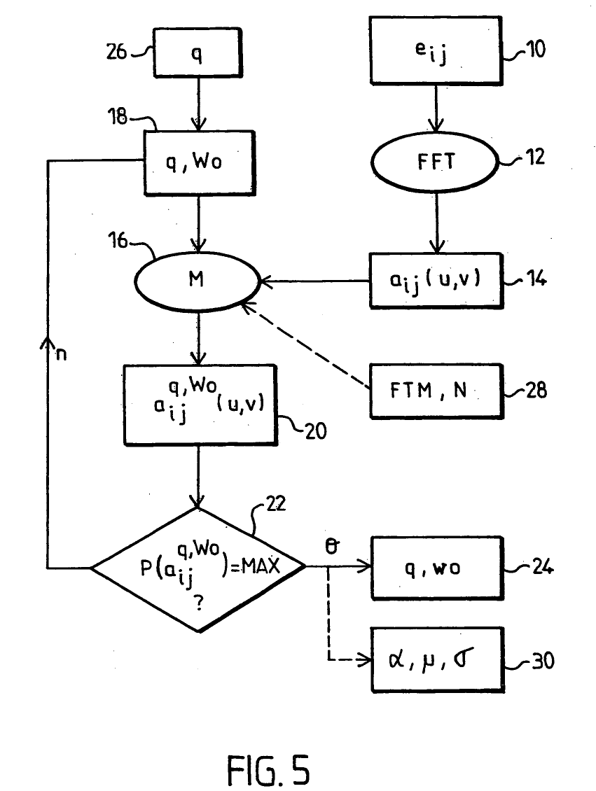

FIG. 5 is a simplified flowchart showing the principal steps in a first embodiment of the method according to the invention.

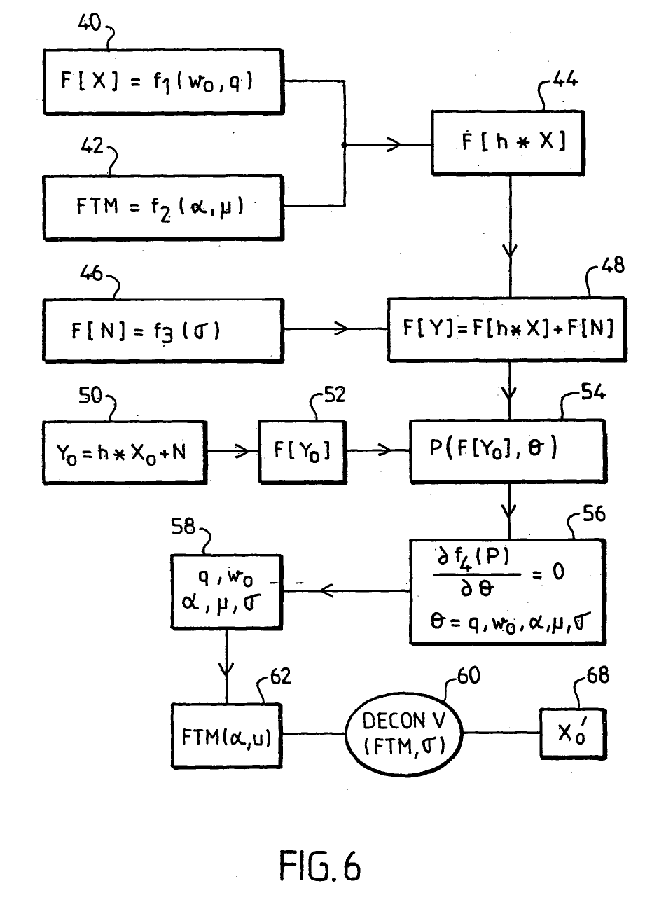

FIG. 6 is a more detailed flowchart.

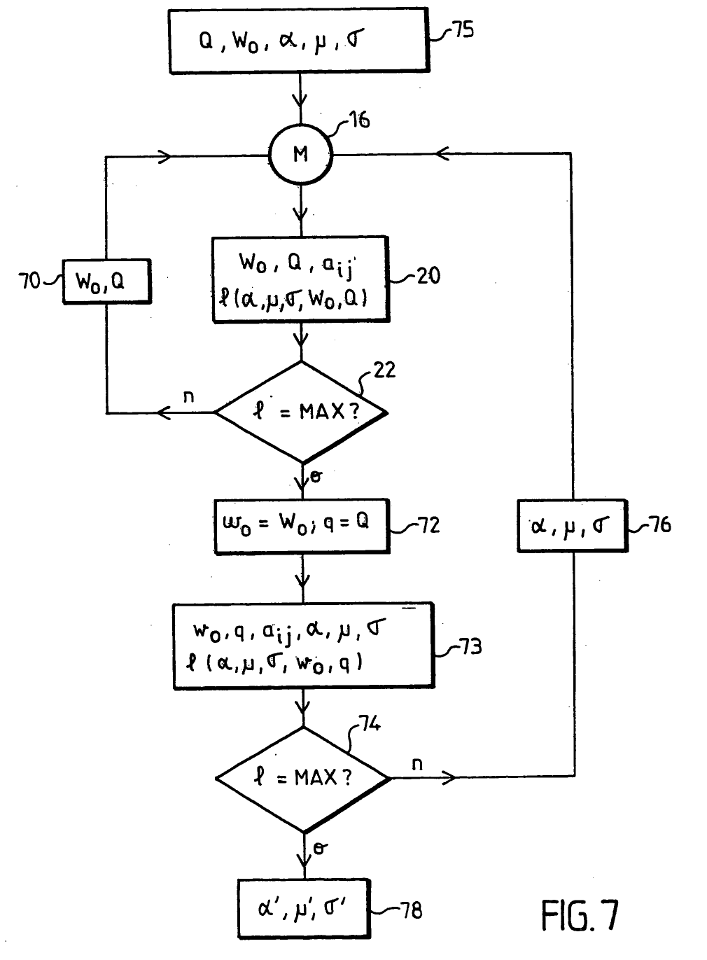

FIG. 7 is a flowchart for a variant of the first embodiment shown in FIG. 5.

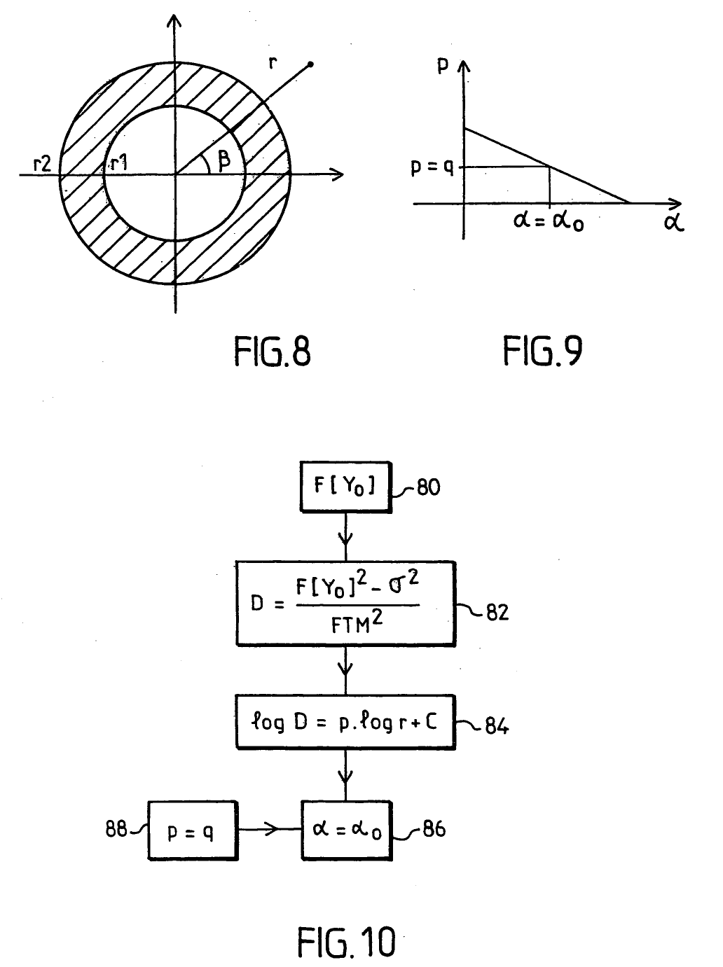

FIG. 8 shows a ring in the frequency domain (in polar co-ordinates), to enable a method according to a second embodiment to be applied.

FIG. 9 shows, as a function of the instrument parameter α, the gradient of a regression line associated with blurring caused by defocusing of the instrument.

FIG. 10 is a flowchart showing the steps of a method according to the above-mentioned second embodiment.

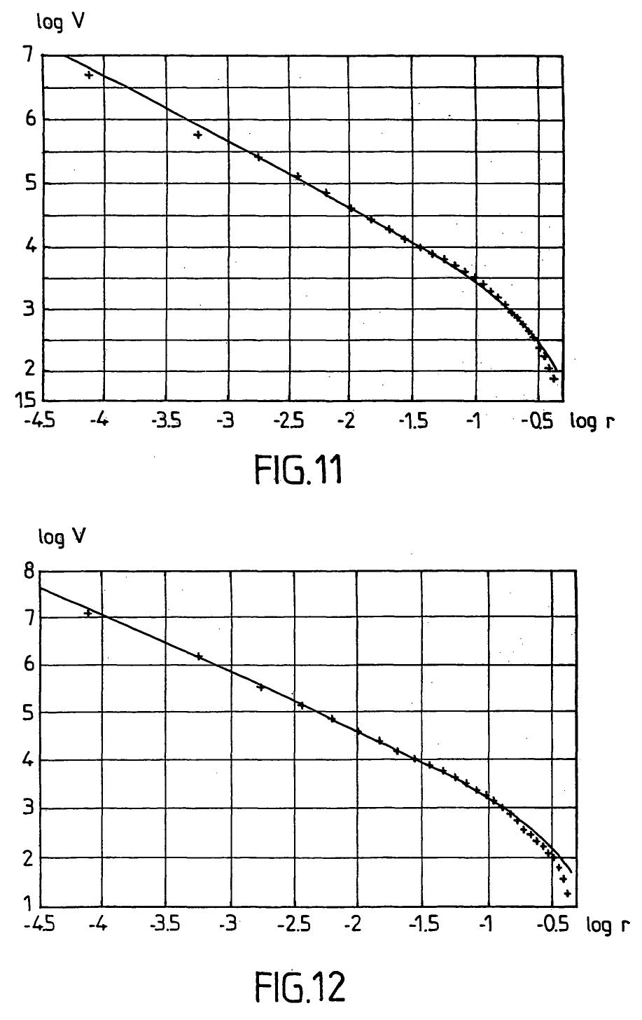

FIG. 11 shows (as a solid line) a variation that is modelled of the logarithm of the variance V taken from the statistical model, as a function of the logarithm of the radial frequencies (in polar co-ordinates), as compared with the values (represented by crosses) actually measured and calculated from the actual image, for the city of Nîmes in France, and

FIG. 12 shows (as a solid line) a variation that is modelled of the logarithm of the variance V taken from the statistical model, as a function of the logarithm of the radial frequencies (in polar co-ordinates), as compared with the values (represented by crosses) actually calculated from the actual image, for the city of Poitiers in France.

The appendix gives the mathematical formulas to which reference is made in the present description.

The following description and the accompanying drawings contain, for the most part, items of a definitive nature. They are thus able to serve not only to facilitate the understanding of the invention but also to assist in defining it, where required.

Reference will first be made to FIG. 1, in which an instrument carried on board an aerial vehicle SAT (a satellite, aircraft or other vehicle) comprises means to supply, by the detection of electromagnetic waves EM, pictures which are taken of the Earth T in the example described. These electromagnetic waves may be both optical waves and infrared waves. The instrument typically comprises a focussing device followed by a plurality of sensors (not shown), such as opto-electronic sensors of the CCD (charge coupled device) type for example. The quality of the image, in terms of sharpness, depends on, amongst other things, the focussing of the instrument, on instrument aberrations, on the diffraction of the waves in the focussing device and on any relative displacement there may be of the satellite in relation to the image to be observed (panning blur).

When the instrument is in service (in a satellite in orbit, for example), it is difficult for it to be adjusted (in the event of it being out of focus or something else). The transfer function h of the instrument enables the defocusing mentioned, the diffraction or some other maladjustment of the instrument to be defined in quantitative terms. The transfer function can be set to parameters and its parameters are thus subject to variation when the instrument is in service.

The CCD opto-electronic sensors themselves suffer from electronic noise N which is subject to variations.

The notation used below will be Y for the image which is constructed by the blurring, noise and other model from an image X which is assumed to be sharp and noise-free. The notation Yₒ will be used for the image actually detected by the instrument and Xₒ for the corresponding sharp and noise-free image which it is the aim to obtain by the image processing which will be seen below.

The present invention advantageously enables the said varying parameters to be determined. Where necessary, there can then be derived from them, from a blurred and noisy image Yₒ which is obtained, an actual image Xₒ which is sharp and noise-free, as will be seen below. What is more, if the defocusing of the instrument is determined quantitatively after the instrument parameter relating thereto has been obtained, it is possible, on the basis of a command emitted from the ground, for the focus of the instrument to be adjusted.

Referring to FIG. 2, the device takes the form, in a first embodiment, of a working station ST comprising a processor μP capable of co-operating on the one hand with a working memory MT and on the other with a non-volatile memory MEM. In the non-volatile memory MEM is stored the modelling module MOD in the form of a computer program intended to be run by the processor. The working station ST comprises two connections L1 and L2 to the outside world, on the one hand to receive image data and on the other to supply values of parameters of the statistical model which is applied and/or of the instrument parameters. The processor μP co-operates with the working memory MT which receives the image data via its connection L1, and loads the program for the FFT module which is provided in the non-volatile memory MEM to cause a Fourier transform, or again a discrete cosine transform DCT, to be applied to the image elements received. The processor then runs the modelling module MOD to apply the statistical model to the coefficients resulting from the transform of the image elements. After comparison with the transforms of the initial image data, the working memory supplies via connection L2 at least one parameter of the statistical model and/or at least one instrument parameter.

Reference will now be made to FIG. 3 to describe another embodiment of the device. In this embodiment, the device comprises at least one pre-programmed component, of the FPGA (field program gate array) type for example, in which the modelling module MOD is stored. There may be another pre-programmed component FFT provided, which is suitable for calculating Fourier transforms, or again discrete cosine transforms DCT, for each image element eᵢⱼ received. Component FFT thus produces the coefficients aᵢⱼ resulting from the transformation which are associated with the image elements eᵢⱼ. Component MOD applies the statistical model to the image element transforms aᵢⱼ and compares the modelled transforms with the initial transforms, to give at least one parameter q, w₀ of the statistical model and/or at least one instrument parameter α, μ, σ. In the example shown, module MOD receives the predefined value of a parameter q of the statistical model, as will be seen below. As a variant, this parameter q may be stored in memory in the component MOD, particularly if provision is made for the device to have to process only one type of image. In another variant, the device performs calculations to extract at least one instrument parameter α, μ, σ, by using the parameters q and wₒ, but without however extracting their quantitative values.

Referring to FIG. 4A, the image to be processed IM is a two-dimensional digital image in the example described. The image elements eᵢⱼ are thus in the form of pixels, with which are associated different grey levels corresponding to one or more spectral bands. For the type of image detected, the number of pixels per row and/or column may be between 256 and 15,000. In a preferred embodiment and where there are sufficient image elements, the image IM is broken down into blocks of 512 elements by 512 elements and an FFT (or DCT) transform is applied to each block. There are obtained, in the frequency domain, the Fourier coefficients (or the coefficients of the DCT transform) aᵢⱼ which are associated with the blocks (FIG. 4B). The breakdown of the image into blocks advantageously enables parameters of instrument aberrations, and particularly the coma aberration, to be estimated. The method preferably makes provision for a mean of the squares of the modules of the coefficients aᵢⱼ to be evaluated before the application of the fractal statistical model below.

In what follows, a more detailed description will be given of the statistical model which is applied to the transforms of the pixels eᵢⱼ.

The instrument detects an image Y and transmits it, in digitised form, pixel by pixel, to a device of the type which is shown in FIG. 2 or FIG. 3. This image Y is capable of being blurred or noisy, whereas an original image X is sharp and noise-free. The sets of image data Y and X are related by a formula (1) which is given in the appendix in which N is added noise which is assumed to be white, Gaussian, steady and of a mean value of zero. H is the convolution operator with the kernel h (which represents the transfer function of the instrument, allowing for the blurring). The Fourier transform of the kernel h corresponds to a modulation transfer function (referred to below as “FTM”) of the instrument in the frequency domain.

The standard deviation a of the noise N, and the modulation transfer function FTM, are subject to variation. To enable the quality of the image to be improved in terms of sharpness, and to enable the noise to be suppressed, it is advisable for these parameters σ and FTM to be determined precisely. In principle, the defocusing blur or the noise which is found in the image as a whole is also found in each pixel of the image.

By applying a Fourier transform to the terms of equation (1), equation (3) is obtained which links the Fourier transform of the image observed to the Fourier transform of the original image multiplied by the factor FTM, which corresponds to the modulation function of the instrument.

The original image X follows a fractal model in this case: the characteristics of the image are invariant as a function of its scale. In the appendix, equations (4), (5) and (6) define the fractal model which is applied to the Fourier transform of the original image X. In equation (4), wₒ and q are the parameters of the model, u and v are the spatial frequencies relating to the co-ordinates x and y of the image (equation (5)), while r is the radius in the frequency domain (equation (6)).

The Fourier transform of the pixels of the image thus follows a Gaussian law of which the standard deviation varies isotropically as a function of the radius r (in polar co-ordinates in the frequency domain), in accordance with equation (4) given in the appendix.

The a priori probability density is given by equation (7) in the appendix. In this equation, Zₚᵣᵢ is the normalisation constant (or partition function) of the a priori probability density. In the example given in the appendix, the sum Σ covers all the coefficients of the Fourier transform of the original image X.

The joint probability of the parameters q, w₀, α, μ and σ which is associated with the observed image Y is given by equation (8), on the basis of the observation equation (3) and steps (9) and (10). In the equation for this joint probability, Z is a normalisation constant which represents the probability density associated with Y and the sum is calculated over all the coefficients of the transform of Y. The parameters wₒ and q are the parameters of the fractal model, while the parameters α, μ are blurring parameters associated with the modulation function of the instrument, as will be seen below. The parameter σ is associated with the noise (equation (2)).

What is sought is the maximum of the joint probability of the parameters q, wₒ, α, μ and σ. For this, an extremum is sought in what is expressed by equation (8). The aim here is preferably to minimise the antilogarithm of the joint probability (equations (11), (12) and (13) in the appendix). In the equation (13) for the logarithm of the normalisation constant, the quantities Nₓ and N_{y} are the numbers of pixels in the image reading horizontally and vertically. They appear in a constant term which will therefore not be taken into account in the search for the extremum below.

This search for the extremum is given by the partial derivatives of equation (11) which are expressed in equation (14), in which θ is one of the five parameters α, μ, σ, wₒ and q. The term l is given by equation (15) and gᵤᵥ is given by equation (16). The partial derivatives of gᵤᵥ in relation to the parameters θ are given by equations (17) and (18).

The points at which the partial derivatives cancel themselves out are then calculated as a function of the image data Y obtained, for each parameter α, μ, σ, wₒ and q, by means of the sums in the frequency domain.

The optimum of the probability (8) is preferably estimated by linear optimisation, using a gradient descent calculation. The Applicants have found that the criterion of the model is difficult to optimise because it has a narrow trough, at the bottom of which the probability remains substantially constant. A conjugated gradient is preferably used in the present case to minimise the antilogarithm of the probability.

Equations (19) to (24) express the dependence of the modulation function FTM in relation to the blurring parameters α and μ. These dependences will be described in detail below.

The modulation function FTM of the instrument is modelled by a product of functions which correspond to different elements of the optical system and it thus makes a quantitative allowance for the events which happen to the system.

Physically, the detector is, in the example described, produced in the form of a matrix of opto-electronic sensors of the CCD type whose pixels are squares of size pₑₓ. The sampling grid can be sized in horizontal increments and vertical increments pₓ and p_{y}. The matrix can be arranged in a network of regular row and columns, or again in a quincunx. As a variant, the detector may comprise only a single strip of CCD sensors and the two-dimensional image is obtained by moving the aerial vehicle (satellite or other type) in a direction secant to the axis of the strip.

The detector may be subject to a charge diffusion phenomenon, this phenomenon being defined quantitatively by an envelope of Gaussian appearance whose parameter is μ in equation (19) given in the appendix, where sinc is the sine cardinal function.

What also has to be considered for an aerial vehicle of the satellite or aircraft type is blurring related to displacement (panning), whose modulation function can be obtained from the model in the appendix (equation (20)), which is given here by way of example and in which vₜᵢ is the speed of the satellite relative to the object observed along the y axis.

As regards the defocusing blurring, the ideal optical modulation function, which corresponds to diffraction by a circular pupil defined quantitatively by a cut-off frequency F_{c} and an occultation ratio τ, is multiplied, as in equation (21) in the appendix, by an exponential term which depends on parameter α. This exponential term is a quantitative definition of the defocusing blur (assumed to be of Gaussian form) and/or of the aberrations, which blue and aberrations are expressed by the parameter α.

These modulation functions FTM are given in the frequency domain, where r is a radial frequency in polar co-ordinates.

The overall modulation function FTM which is the result of all these events is given by the product of the modulation functions which are linked to each of the events (equation (23) in the appendix) and its expression is given by equation (24) in the appendix. From equations (16) and (24) are derived the partial derivatives of gᵤᵥ in relation to α and μ, which are expressed in equation (18).

In the course of their tests, the Applicants have found that there is little variation in parameter q for one and the same type of image. This is why pictures taken by satellite of a city of average size (Nîmes or Poitiers in France) had a parameter q which was systematically close to 1.1, whereas pictures taken of the countryside generally have a factor q which is closer to 1.3.

Reference will now be made to FIG. 5 to describe a method in a first embodiment. In step 10, the image data relating to the pixels eᵢⱼ is received, and in step 12 a Fourier transform FFT (or a DCT transform) is applied to this data. Also, in step 26 the parameter q is laid down as a function of the type of image to be observed (town, country or other). In the example shown in FIG. 5, the quantity W₀ is a normal value for parameter wₒ, which normal value is to be optimised to refine the fractal model which is applied in step 16. In step 18, the parameter q is thus laid down and a normal value wₒ is also laid down, provisionally, for the parameter wₒ. In step 16, the model is applied to the Fourier coefficients aᵢⱼ which were obtained in step 14. In a more elaborate embodiment, modelling of the modulation function FTM of the instrument, and of its noise N, may be undertaken in step 28, particularly if it is desired to obtain the parameters α, μ and σ in step 30 to allow the image to be processed to make it sharp and noise-free, as will be seen below.

In step 20, the modelled Fourier coefficients are obtained, and a maximum probability test 22 is performed on them, for example by looking for the minimum of the antilogarithm of the probability, as described below. If the value Wₒ assigned to parameter wₒ does not correspond to the maximum probability, step 18, in which the value Wₒ is refined, and steps 16 and 20, are repeated until a value Wₒ is obtained which corresponds to the maximum probability which was estimated in step 22. Finally, from the latter value, the value of parameter wₒ is derived in step 24.

Processing as in the embodiment shown in FIG. 5 has been applied to an image of Nîmes and an image of Poitiers in France by taking a value of 1.1 for parameter q. What is more, a modulation function FTM has been modelled by taking into account the charge diffusion on the sensors, but in which a value of zero was assigned to parameter μ. In FIGS. 11 and 12 are shown the variations in the logarithm of the variance V (given by the expression V=wₒ²·r^{-2q}), as a function of the logarithm of the radial frequency r. The variations of the fractal model are shown as a solid line, whereas the values measured on the image obtained are represented by crosses. A satisfactory match is obtained between the model and the values directly measured.

Reference will now be made to FIG. 6 to describe in more detail the model which was applied in step 16, together with the finding, in step 22, of the maximum probability by taking into account, in the embodiment concerned, the modulation function FTM of the instrument and the noise N.

In a first phase, the fractal, modulation function FTM and noise models which come into play in the processing are constructed. In step 40, the fractal model of the original image is constructed, as a function of the parameters wₒ and q of the model and in accordance with equation (4) in the appendix. In step 42, the modulation function FTM of the instrument is modelled with the help of parameters α and μ in accordance with equation (24) in the appendix. In step 46, the Fourier transform of the noise N (assumed to be Gaussian) is modelled in accordance with equation (2) in the appendix. The model which covers the modulation function FTM is constructed in step 44 in accordance with equation (9) in the appendix and, finally, the Fourier transform of the image obtained Y is modelled in step 48, while also taking the noise into account, in accordance with equation (10) in the appendix. The data for the image actually observed does not as yet come into play in the above steps.

Below, there will now be described the way in which the processing continues, on the base of the image actually detected. The data on the observed image Yₒ is recovered in step 50, and a Fourier transform (or a DCT transform) is applied to it in step 52. In step 54, the probability P of the model which was constructed in step 48 and applied to the coefficients of the transform of Yₒ is shaped in accordance with equation (8) in the appendix. The points θ at which the partial derivatives of the probability P cancel out are then found. What is done in practice is, in step 56, to find the values of q, wₒ, α, μ and σ for which the antilogarithm of the probability P falls to minimum absolute values, in accordance with equations (17) and (18) in the appendix.

At the end of the processing, in step 58, the parameters q, wₒ, α, μ and σ are recovered.

In what follows, there will be described a continuation of the processing as effected by a more elaborate version of the embodiment shown in FIG. 5. In step 62, the modulation function FTM of the instrument is reconstructed from parameters α and μ. The spectrum of Yₒ is deconvolved from parameter σ and the modulation function FTM in step 60 and finally, in step 68, an image Xₒ′ close to the original image and substantially sharp and noise-free is regained. Hence, by starting with a blurred and noisy image Yₒ (step 50), this image Yₒ is processed to obtain a sharp and noise-free image Xₒ′ in step 68.

In the embodiment which is shown in FIG. 7, the aim is not to extract an exact value for the parameters q and wₒ of the fractal model but rather for the instrument parameters α, μ and σ.

Overall, the embodiment provides two mutually imbricated loops, one to refine the values of the parameters q and wₒ of the fractal model and the other to refine the values of the instrument parameters α, μ and σ. This embodiment is advantageously suited to types of image for which the parameters q and wₒ are not known a priori. The processing takes as its point of departure the so-called “marginalized” probability which is expressed by equation (26) in the appendix. In particular, the maximum of the marginalized probability VM is sought by refining (first processing loop) the normal values Q and Wₒ of the parameters q and wₒ of the fractal model and by refining (second processing loop) the normal values α, μ and σ of the instrument parameters. The partial derivatives are no longer calculated in this case because the refined values Q and Wₒ of the parameters q and wₒ depend on the values of the instrument parameters α, μ and σ (equation (27) in the appendix).

At the outset, the first thing done is to assign normal values Q and W₀ to the parameters q and w₀ of the fractal model, and normal values α, μ and σ to the instrument parameters (step 75). Test 22 enables the values Q and W₀ to be refined (in step 70) and the first loop is exited when the maximum probability is achieved (to within a tolerance) with the values α, μ and σ laid down at the outset. In step 72, the values Q and W₀ which have been refined in this way are assigned to the parameters q and w₀.

The calculating process then continues with the calculation of the probability (step 73) using on the one hand the above refined values Q and W₀ and on the other the normal values α, μ and σ of the instrument parameters which it is the aim to refine in this second loop. Test 74 on this probability enables the normal values α, μ and σ to be refined in step 76. The refined values of α, μ and σ are re-injected into the first loop to enable those values of the parameters q and w₀ which correspond with the maximum probability to the new values of α, μ and σ to be determined. The processing stops when the maximum probability is achieved in test 74 (to within a tolerance), and those estimated values αμ, μ′ and σ′ of the instrument parameters which satisfy this maximum probability are recovered in step 78.

In the example shown in FIG. 7, the aim is to estimate only the instrument parameters. As a variant, provision may also be made, in step 78, for those values of the parameters q and w₀ which satisfy the maximum probability to be recovered as well as the estimated values α′, μ′ and σ′ of the instrument parameters.

Reference will now be made to FIGS. 8, 9 and 10 to enable a second embodiment of the invention to be described. In this case, the method takes as its point of departure a consideration of rings of a radius r lying between a lower value r1 and an upper value r2, in the domain of the radial frequencies r (in polar co-ordinates), to allow an energy D to be estimated in the frequency domain. In step 82 of the flowchart shown in FIG. 10, the spectral power obtained by Fourier (or DCT) transform of the recovered image Yₒ is deconvolved by subtracting therefrom the variance σ² of the noise and by dividing the result of the subtraction by the square of the modulation function FTM. In this way, there is modelled in step 82 an energy D in the ring shown in FIG. 8. In step 84, a linear regression is estimated between the logarithm of this energy D and the logarithm of the radial frequency r. This regression is of a gradient p which is the parameter shown on the y axis of the graph in FIG. 9.

On the one hand the energy D will be expressed as a function of r^{-2q} (equation (9) in the appendix). On the other hand the modulation transfer function FTM will be expressed by an exponential function of the term −αr². The gradient p thus varies linearly in relation to the parameter α (FIG. 9).

Thus, knowing a predetermined value of the parameter q as a function of the type of image to be processed when the gradient p is the value of q laid down at the outset, the quantitative value α₀ of the parameter α is estimated by coincidence.

This processing is faster and more robust than processing in the previous embodiments. If the parameter q of the fractal model is known for a type of image, it enables the defocusing parameter α to be obtained when the image obtained is blurred. Other parameters (μ, σ and w₀) may of course be obtained by means of this processing by regression, in which it is possible for a plurality of parameters to be varied. Nevertheless, the linear regression does not enable the parameter q to be estimated reliably where there is spectral folding (particularly at the high frequencies). What will be used instead will be the general method in FIG. 7.

The present invention is not of course limited to the embodiments described above; it covers other variants.

In this way, it will be appreciated that the recovered image may be three-dimensional, while the image data is voxels. The image may also be one-dimensional, particularly in an application where the sensors are arranged in a strip to form a detection array. Where appropriate, an image obtained will correspond to an angle of incidence of the array.

The term “image” is to be construed in a broad sense and may equally well relate to a one-dimensional signal. A signal characterised by a brightness of light for example may represent an optical or infrared measurement. If a measurement of this kind is degraded, for example by persistence blurring, modelling of the modulation function of this blurring, followed by a fractal model associated with the one-dimensional point, enables the blurring to be quantified and the measurement then to be corrected. What may be involved in this case is a time signal such as a measurement made as a function of time.

The present invention may also be applied to radar detection, particularly to enable the noise of the detectors to be corrected. The construction of a noise model suited to this application is undertaken beforehand.

The events connected with a maladjustment of the instrument (defocusing, sensor noise, etc.) are described above by way of example. Other events, to which parameters can be assigned, may be involved in the estimation of the modulation function FTM of the instrument. Similarly, the FTM formulas employed above are given by way of example in the appendix. Other suitable expressions of the FTM may however be envisaged, as dictated by the nature of the events.

In the example described above it was satellite or aerial images which were considered but the invention may of course be applied to images of any other type and in particular to microscopic images.

The present invention may, in a sophisticated version, take the form of processing of the blurred (and possibly noisy) image obtained with a view to obtaining a sharp image. It may also take the form of processing only to obtain the parameters of the blurring or noise (α, μ, σ), or again, in a simpler version, only the parameters q and w₀ of the fractal model. Where the parameter q can be laid down in advance (particularly as a function of the type of image), the processing may be applied solely to given a value for the parameter w₀.

Provision may be made for the parameters α, μ and, where required, σ of the modulation function to be derived, in a subsequent and separate processing operation, from the parameters q and w₀ of the fractal model, with a view to processing the image detected in order to obtain a sharp, noise-free image.

The steps in the flowcharts shown in FIGS. 5, 6, 7 and 10 enable instructions or sets of instructions to be defined for computer programs capable of being run by a device according to the invention. This being the case, the present invention is also directed to programs of this kind.

The formulas in the appendix are given for a Fourier transform FFT applied to image elements but, except for a few multiplying coefficients, similar formulas are obtained with a discrete cosine transform DCT.

Appendix

Y=HX+N where HX=h*X (1)

where N=N₁ (O,σ²) is the actual Gaussian noise

N₂ (O,σ²) is the two-dimensional Gaussian law whose covariance matrix is ½σ²I

(2)

F[X]=F[X].FTM+F[N] where F[N]=N₂ (O,σ²) (3)

F[X]ᵤᵥ=N₂(0,1).ω_{0.r}^{-q} (4)

$$u {{↔}_{⟵}}^{} \frac{1}{2} , \frac{1}{2} \begin{matrix}≡ \\ {\approx }_{ … }\end{matrix} and v {{↔}_{⟵}}^{} \frac{1}{2} , \frac{1}{2} \begin{matrix}≡ \\ {\approx }_{ … }\end{matrix} \qquad ( 5 )$$

r=\sqrt{u²+u²} (6)

$$\begin{matrix}P ( X \vert {w}_{0 , q} ) = \frac{1}{{Z}_{pri}} {ⅇ}^{- Σ \vert {ℱ [ X ]}_{u υ} {\vert}^{2} / {( {w}_{0} \cdot {r}^{- q} )}^{2}} & ( 7 ) \\ P ( Y \vert α , μ , σ , {w}_{0} , q ) = \frac{1}{Z} {ⅇ}^{- Σ \vert {ℱ [ X ]}_{u υ} {\vert}^{2} / [ {( {w}_{0} \cdot {r}^{- q} )}^{2} {F}_{T} {M}^{2} + {σ}^{2} ]} & ( 8 )\end{matrix}$$

F[h*X]ᵤᵥ=N₂(0, ω₀².r^{-2g}.FTM²) (9)

F[Y]ᵤᵥ=N₂(0, ω₀².r^{-2q}.FTM²+σ²) (10)

$$\begin{matrix}- log P ( Y \vert α , μ , σ , {w}_{0} , q ) = log Z + {\sum }_{u , υ} \frac{\vert {ℱ [ Y ]}_{u υ} {\vert}^{2}}{{w}_{0}^{2} \cdot {r}^{- 2 q} F T {M}^{2} + {σ}^{2}} & ( 11 ) \\ log Z = log {\prod }_{u , υ}^{} π ( {w}_{0}^{2} \cdot {r}^{- 2 q} F T {M}^{2} + {σ}^{2} ) & ( 12 ) \\ = {N}_{x} {N}_{y} log π + {\sum }_{u , υ} log ( {w}_{0}^{2} \cdot {r}^{- 2 q} F T {M}^{2} + {σ}^{2} ) & ( 13 ) \\ \frac{\partial l}{\partial θ} = {\sum }_{u , υ} \frac{\partial {g}_{u υ}}{\partial θ} \frac{1}{{g}_{u υ}} [ 1 - \frac{\vert {ℱ [ Y ]}_{u υ} {\vert}^{2}}{{g}_{u υ}} ] & ( 14 ) \\ l ( α , μ , σ , {w}_{0} , q ) = {\sum }_{u , υ} [ log ( {w}_{0}^{2} \cdot {r}^{- 2 q} F T {M}^{2} + {σ}^{2} ) + \frac{\vert {ℱ [ Y ]}_{u υ} {\vert}^{2}}{{w}_{0}^{2} \cdot {r}^{- 2 q} F T {M}^{2} + {σ}^{2}} ] & ( 15 )\end{matrix}$$

gᵤᵥ=ω₀².r^{-2g}FTM²σ² (16)

$$\begin{matrix}\frac{\partial {g}_{u υ}}{\partial {w}_{0}} = 2 {w}_{0} \cdot {r}^{- 2 q} F T {M}^{2} , \frac{\partial {g}_{u υ}}{\partial q} = - 2 {w}_{0}^{2} {r}^{- 2 q} F T {M}^{2} log r , \frac{\partial {g}_{u υ}}{\partial σ} = 2 σ & ( 17 ) \\ \frac{\partial {g}_{u υ}}{\partial α} = - 2 {r}^{2} \cdot {w}_{0}^{2} \cdot {r}^{- 2 q} F T {M}^{2} , \frac{\partial {g}_{u υ}}{\partial μ} = - 2 {u}^{2} \cdot {w}_{0}^{2} \cdot {r}^{- 2 q} F T {M}^{2} & ( 18 ) \\ {FTM}_{det} = {ⅇ}^{- μ {u}^{2}} sin c ( π u \frac{{p}_{x}}{{p}_{ex}} ) sin c ( π υ \frac{{p}_{y}}{{p}_{ex}} ) & ( 19 ) \\ {FTM}_{panning} sin c & ( 20 )\end{matrix}$$

FTM_{optical}e^{Δr}^{²} FTM_{diffrac} (21)

$${FTM}_{diffrac} = \frac{J ( 1 , 1 , 2 \frac{τ}{{f}_{c}} ) + J ( τ , τ , 2 \frac{τ}{{f}_{c}} ) - 2 J ( 1 , τ , 2 \frac{τ}{{f}_{c}} )}{π ( 1 - {τ}^{2} )} \qquad ( 22 )$$

FTM FTM_{det} FTM_{optical} FTM_{panning} (23)

$$\begin{matrix} FTM = {ⅇ}^{- α {τ}^{2} - μ {u}^{2} } sin c ( π u \frac{{p}_{x}}{{p}_{ex}} ) sin c ( π υ \frac{{p}_{y}}{{p}_{ex}} ) sin c ( π υ \frac{{υ}_{t i}}{{p}_{ex}} ) {FTM}_{diffrac} & ( 24 ) \\ VM = arg {max}_{α , μ , σ} P ( Y \vert α , μ , σ ) & ( 25 ) \\ P ( Y \vert α , μ , σ ) = \int {\int }_{{( {R}^{+} )}^{2}}^{} P ( Y \vert α , μ , σ , {W}_{0} , Q ) ⅆ {W}_{0} ⅆ Q & ( 26 ) \\ ≃ k P ( Y \vert α , μ , σ , {w}_{0} , q ) & \\ ( {w}_{0} , q ) = arg {max}_{{W}_{0} , Q} P ( Y \vert α , μ , σ , {W}_{0} , Q ) & ( 27 )\end{matrix}$$

1. Method of processing digital images acquired by the detection of electromagnetic waves, characterised in that it comprises the following steps:
a) recovering (10) image data (eᵢⱼ) relating to constituent elements of an initial image,
b) applying (12) at least one spectral transformation (FFT, DCT) to at least some of the image elements,
c) in the case of at least some of these elements, applying (16) to the transforms (aᵢⱼ) of the elements an overall statistical modelling (M) which can be set to parameters, and
d) comparing (22) the modelled transforms (aᵢⱼ^{qw0}) with the initial transforms (aᵢⱼ) in order to obtain a close approximation of at least one parameter (q, w₀, α, μ, σ) which comes into play in the statistical model applied.

2. Method according to claim 1, characterised in that the statistical model is of the fractal type and comprises the assignment of at least one parameter (q) which is suitable for defining a statistical variation (w₀.r⁻⁹) of said transforms.

3. Method according to either of claims 1 and 2, characterised in that said spectral transformation in step b) is of the Fourier transformation type, and in that the statistical model covers Fourier coefficients (aᵢⱼ) resulting from the transformation.

4. Method according to either of claims 1 and 2, characterised in that said transformation in step b) is of the discrete cosine transformation (DCT) type, and in that the statistical model covers coefficients (aᵢⱼ) resulting from the transformation.

5. Method according to either of claims 3 and 4 taken in combination with claim 2, characterised in that the parameter (q, w₀) of the fractal model is suitable for defining a statistical variation (w₀.r⁻⁹) of said coefficients in the frequency domain (x).

6. Method according to claim 5, characterised in that said statistical variation substantially follows a Gaussian curve, and in that the model assigns two parameters (q, w₀), one (q) of the parameters of the fractal model being representative of the attenuation of the Gaussian curve with distance from its axis and the other parameter (w₀) being a multiplying coefficient.

7. Method according to one of the foregoing claims, characterised in that step d) comprises finding an extremum in a mathematical expression (-log(P)) representing said comparison.

8. Method according to claim 7, characterised in that the comparison in step c) comprises finding a maximum probability (P).

9. Method according to claim 8 taken in combination with one of claims 5 to 7, characterised in that the finding of the maximum probability brings into play a probability (P) density over the entire frequency domain, which involves all the elements of the image (NₓN_{y})

10. Method according to claim 9, characterised in that it makes provision for linear optimisation (56) of the probability density.

11. Method according to claim 10, characterised in that the linear optimisation employs a gradient descent calculation.

12. Method according to one of the foregoing claims in which the statistical model brings into play at least one first parameter (α, μ, σ) and at least one second parameter (q, w₀), characterised in that the comparison step c) comprises the following operations:
c1) assigning (26) an approximate value (α, μ, σ) to the first parameter,
c2) assigning (18) an approximate value (Q, W₀) to the second parameter,
c3) comparing (22; 74) the modelled transforms with the initial transforms, and
c4) successively adjusting (18) the value of the second parameter (q, w₀) by repeating operations c2) and c3).

13. Method according to claim 12, characterised in that step c) also comprises the following operations:
c5) laying down (72) the value of the second parameter (q, w₀) as adjusted in operation c4), and
c6) successively adjusting (76) the value of the first parameter (α, μ, σ) by repeating operations c1) and c3).

14. Method according to claim 13 taken in combination with claim 8, characterised in that it comprises a repetition of operations c1), c2), c3), c4), c5) and c6) until values which substantially correspond to the maximum probability are obtained for the first and second parameters.

15. Method according to one of the foregoing claims in which the statistical model brings into play at least one first parameter (α) and one second parameter (q), characterised in that the comparison step c) comprises the following operations:
c1) determining (84) a dependence between the first and second parameters (q, α), preferably a dependence of the linear regression type,
c2) laying down (88) the second parameter (q), and c3) deriving therefrom (86) an estimate of the first parameter (α).

16. Method according to one of the foregoing claims, characterised in that the statistical model also brings into play at least one instrument parameter (α, μ, σ) which is subject to variations, and in that, in step c), a close approximation is obtained (30; 58) of this instrument parameter, which enables the initial image to be processed (60, 62, 64, 66, 68) to increase the quality thereof.

17. Method according to claim 16, characterised in that the instrument parameters is suitable for quantitatively representing an image degradation due to one of the following events: diffusion of the electromagnetic waves during detection (FTM_{det}), defocusing and/or an aberration in the forming of the image (FTMₒₚₜ), electronic noise at reception (N).

18. Method according to claim 17, characterised in that it comprises a step prior to step b), for modelling (40, 42, 46) an instrument modulation function associated with at least one of said events, this function bringing into play said instrument parameter.

19. Method according to claim 18 taken in combination with claim 2 and one of claims 12 to 15, characterised in that said first parameter (α, μ, σ) is intrinsic to the model of the instrument modulation function (FTM, N) whereas the second parameter (q, w₀) is intrinsic to the fractal model.

20. Method according to either of claims 18 and 19 taken in combination with claim 6, characterised in that the modulation function comprises at least one envelope of Gaussian appearance.

21. Application of the method according to one of the foregoing claims to the processing of satellite or aerial images obtained by optical or infrared detection.

22. Device for performing the method according to one of claims 1 to 20, characterised in that it comprises a statistical modelling module (MOD), comprising an input for recovering spectral transforms of constituent elements (aᵢⱼ) of an initial image and arranged:
to apply overall statistical modelling, which can be set to parameters, to at least some of the element transforms, and
to compare the modelled transforms with the initial transforms, with a view to obtaining a close approximation of at least one parameter q, w₀, α, μ, σ) which comes into play in the statistical model applied.

23. Device according to claim 22, characterised in that it comprises memory means (MEM) containing program data relating to the modelling module and calculating means (μP) arranged to co-operate with the memory means to put the modelling module (MOD) into practical operation.

24. Device according to claim 22, characterised in that the modelling module comprises memory means and calculating means which are combined in one and the same component (FPGA, VLSI).

25. Device according to one of claims 22 to 24, characterised in that it is intended to be carried on board an aerial vehicle (SAT).

26. Device according to one of claims 22 to 25, characterised in that it comprises an output (L2) suitable for supplying said parameter of the statistical model.

27. Computer software product intended to be stored in a device according to one of claims 22 to 26 to put at least the modelling module (MOD) into practical operation.
